(19) United States
(12) Patent Application Publication
(10) Pub. No.: US 2003/0220463 A1
(43) Pub. Date: Nov. 27, 2003

(54) Polyurethane dispersions

(75) Inventors: Ibrahim Bechara, Carmel, NY (US); Anatoly Lipkin, Congers, NY (US)

Correspondence Address: Michael P. Dilworth, Crompton Corporation, Benson Road, Middlebury, CT, 06749, US

(73) Assignee: CROMPTON CORPORATION

(21) Appl. No.: 10/439,922

(22) Filed: May 16, 2003

Related U.S. Application Data
(60) Provisional application No. 60/382,629, filed on May 24, 2002.

(51) Int. Cl. C08G 18/00

(52) U.S. Cl. 528/44

(57) ABSTRACT

Polyurethane dispersions are disclosed that are prepared from low free-diisocyanate polyurethane prepolymers modified by the addition of pendent anionic, cationic, or nonionic moieties.

We claim the benefit under Title 35, United States Code, §120 of U.S. Provisional Application No. 60/382,629, filed May 24, 2002, entitled POLYURETHANE DISPERSIONS.

### BACKGROUND OF THE INVENTION

1. Field of the Invention

The present invention relates to polyurethane dispersions. More particularly, the present invention relates of polyurethane dispersions prepared from modified prepolymers having a low free-diisocyanate content.

2. Description of Related Art

It is generally accepted that producing polyurethane dispersions from highly reactive diisocyanates, such as the symmetrical methylene bis-4,4′-(isocyanato diphenyl) (MDI) and hexamethylene diisocyanate (HDI), by conventional technology is a significant problem. Conventional prepolymers from these isocyanates can have significant isocyanate monomeric content depending on the ratio of the isocyanate to the polyol used to form the prepolymer. These residual monomeric isocyanates, i.e., free isocyanates, are generally more reactive with water than the polymeric ones so that when these prepolymers are reacted with internal emulsifying agents, such as dimethylol propionic acid, and added to water, the reactivity of the monomeric isocyanate is so high that excessive, hard to filter, grit forms, and in many cases gelation of the dispersion occurs rendering the finished product useless or substantially so. In order to make useful products from such conventional prepolymers, the industry has resorted to special processes that are more expensive to use. A known acetone process for making dispersions from conventional HDI based prepolymers, where the prepolymers are completely extended (fully reacted) before being added to water, requires an inordinate amount of solvent, usually acetone, to reduce viscosity and permit transfer and dispersion into water. This technique requires stripping the flammable acetone afterward, which necessitates explosion-proof equipment. More importantly, the process is of low through-put owing to the occupation by the acetone of a substantial part of the reactor. Hence, the finished product is more expensive to make.

Another known process for making dispersions from conventional MDI prepolymer requires special equipment for a continuous process of in-line homogenization that is economical only for very large volumes of a single type of product. Its design is not very economical for producing a variety of products in a relatively small volume, such as can be employed in the process of the present invention.

U.S. Pat. No. 3,479,310 discloses a polyurethane ester prepared by dispersing in water a polyurethane containing from about 0.02 to about 1% by weight salt groups. It is said that the polyurethane can be dispersed without the aid of additional emulsifying agent.

U.S. Pat. No. 4,857,565 discloses a continuous process for the production of aqueous polyurethane dispersions by continuously mixing solutions of polyurethanes or isocyanate prepolymers dissolved in an organic solvent with water and subsequently continuously removing at least a portion of the solvent using a circulation-type evaporator. The production of coatings or adhesives by applying the aqueous polyurethane dispersions to a substrate is also disclosed.

U.S. Pat. No. 5,077,371 discloses a low-free toluene diisocyanate prepolymer formed by reaction of a blend of the dimer of 2,4-toluene diisocyanate and an organic diisocyanate, preferably isomers of toluene diisocyanate, with high molecular weight polyols and optional low molecular weight polyols. The prepolymer can be further reacted with conventional organic diamines or organic polyol curatives to form elastomeric polyurethane/ureas or polyurethanes.

U.S. Pat. No. 5,696,291 discloses the preparation and use of quarternized bis hydroxy alkyl amines by the reaction of a tertiary amine and an alkylene oxide in a strong acid system. Cationic polyurethane compositions containing pendent hydroxy alkyl groups and methods for their preparation are also disclosed.

U.S. Pat. No. 5,703,193 discloses a process for reducing the amount of residual organic diisocyanate monomer in a polyurethane prepolymer reaction product mixture which comprises distilling the polyurethane prepolymer reaction product mixture in the presence of a combination of at least one inert first solvent with a boiling point below the boiling point of the residual organic diisocyanate monomer and at least one inert second solvent with a boiling point above the boiling point of the residual organic diisocyanate monomer, at a temperature which exceeds the vaporization temperature of the residual organic diisocyanate monomer and which is below the decomposition temperature of the polyurethane prepolymer.

U.S. Pat. No. 5,959,027 discloses that a polyurethane/urea/thiourea latex having a narrow molecular weight polydispersity and sub-micron particle size can be prepared by first preparing a high internal phase ratio (HIPR) emulsion of a polyurethane/urea/thiourea prepolymer, then contacting the emulsion with a chain-extending reagent under such conditions to form the polymer latex.

U.S. Pat. No. 6,087,440 discloses that a polyurethane/urea/thiourea latex having a narrow molecular weight polydispersity and sub-micron particle size can be prepared by first preparing a high solids (between about 65% and 74% solids) latex of a polyurethane/urea/thiourea prepolymer, then contacting the emulsion with a chain-extending reagent under such conditions to form the polymer latex.

WO 00/61653 discloses a process for preparing a polyurethane film comprising two steps. The first step comprises preparing a nonionic prepolymer formulation comprising a diisocyanate, and active hydrogen containing material, and a monol. The second step comprises preparing an aqueous dispersion of the prepolymer, in the presence of a surfactant. Both steps occur in the substantial absence of an organic solvent. Also disclosed is a polyurethane film and an aqueous dispersion useful for preparing such films. It is said that the process provides increased shear stability and dispersions that do not settle or coagulate prematurely, and that the films do not include the dermal irritants that occur in natural rubber latex. It is also said that the films and dispersions are thus suitable for use in, for example, medical applications.

WO 01/40340 A2 discloses polyurethane prepolymers having a reduced amount of unreacted monomeric diisocyanate, particularly diphenylmethane diisocyanate (MDI), prepared by distilling the prepolymer reaction product in the presence of at least one inert solvent whose boiling point is slightly below that of the monomeric diisocyanate, and to high performance elastomers from the thus obtained prepolymers using diamine and/or diol chain extenders.

The disclosures of the foregoing are incorporated herein by reference in their entirety.

### SUMMARY OF THE INVENTION

This invention relates to low free-diisocyanate (LF) prepolymers and a process for making polyurethane dispersions from these prepolymers. The resulting compositions of anionic, cationic, or nonionic aqueous polyurethane dispersions from these modified LF prepolymers are also disclosed. The modification and low free monomeric diisocyanate content of these prepolymers, in combination with strict control of reaction temperature and acidic reaction retarders, permit the preparation of grit-free polyurethane dispersions having good stability and excellent colloidal properties. Films from these dispersions have outstanding mechanical properties and perform well in a variety of applications, including the manufacture of all-urethane gloves, coatings for wood, plastics, and metals, and adhesives for similar substrates.

The process of the present invention permits the preparation of polyurethane dispersions from fast reacting aromatic (MDI based) or aliphatic (HDI based) diisocyanates by conventional technologies, including dispersing prepolymers in water or adding water to a prepolymer—a technique known in the art as the “inverse process”.

It has also now been found that, by modifying the LF prepolymers with polyols containing pendent carboxyl, sulfonic, or polyoxyethylene moieties, dispersions can be made that are free of organic solvents. Examples of such polyols that have been used successfully in the modification of the LF prepolymers is caprolactone CAPA 587047, available from Solvay Company, and made from caprolactone and 2,2′-di(hydroxymethyl)-propionic acid (DMPA). This is important because it allows end-users to be compliant with strict environmental laws that mandate very low volatile organic content. In some states, such as California, the elimination of M-Pyrol co-solvent, a frequently used co-solvent in the preparation of polyurethane dispersions, from all formulated lacquers and paint is required.

Although LF (low free monomeric isocyanate) prepolymers are known in the art, e.g., U.S. Pat. Nos. 5,077,371 and 5,703,193, LF prepolymers with pendent emulsifying groups are, to the best of our knowledge, not known.

The use and modification of LF prepolymers enables the manufacture of polyurethane dispersions from highly water reactive prepolymers by the most economical conventional method.

More particularly, the present invention is directed to a composition of matter comprising a low free-diisocyanate polyurethane prepolymer modified by the addition of pendent anionic, cationic, or nonionic moieties.

In another embodiment, the present invention is directed to a method for making an aqueous polyurethane dispersion comprising subjecting a low free-diisocyanate polyurethane prepolymer modified by the addition of pendent anionic, cationic, or nonionic moieties to high shear mixing in the presence of water.

Such polyurethane dispersions are useful, for example, in the manufacture of gloves, adhesives, coatings, sealants, inks, and the like.

### DESCRIPTION OF THE PREFERRED EMBODIMENTS

The present invention pertains to LF prepolymers having internal emulsifying groups and to polyurethane dispersions prepared therefrom. The invention also pertains to a process for making these dispersions. The dispersions of the present invention can be made by the modification of any LF prepolymer that, in turn, is made from aliphatic or aromatic isocyanates and mixtures thereof, and polyols, such as polyether polyols, polyester polyols, polycarbonate polyols, polycaprolactone polyols, acrylic polyols, hydroxyl-terminated unsaturated and hydrogenated polybutadiene, and the like, and mixtures thereof.

The polyether polyols can be derived from any glycol initiators and alkylene oxide, such as propylene oxide, ethylene oxide, or mixtures thereof The polyether polyol can also be made by the polymerization of tetrahydrofurans.

The polyester polyols are well known in the art and are generally made from diacids, diols, and triols. The ratio of these components is adjusted to suit the ease of processibility and practicality of the end use.

Hybrid polyester/polyethers, such as those, for example, made from glycol adipate and poly tetramethyene glycol can also be used in the present invention. Similarly, polycarbonates and polycaprolactones can be made from different initiators as is well known in the art.

To prepare LF prepolymers, one process that can be used is that described in U.S. Pat. No. 5,703,193 wherein certain inert solvents are used to facilitate the removal of residual diisocyanate monomers from the prepolymers by distillation. The distillation is generally conducted in agitated thin-film distillation equipment, also known as thin film evaporators, wiped film evaporators, short-path distillers, and the like. Preferably, the agitated thin-film distillation equipment comprises internal condensers and vacuum capability. Two or more distillation units can, optionally, be used in series. Such equipment is commercially available, e.g., Wiped Film Stills from Pope Scientific, Inc.; Rototherm “E” agitated thin-film processors from Artisan Industries, Inc.; Short-Path Evaporators from GEA Canzler GmbH & Co.; Wiped-Film Evaporators from Pfaudler-U.S., Inc.; Short Path Distillers from UIC Inc.; Agitated Thin-Film Evaporators from Luwa Corp.; and SAMVAC Thin Film Evaporators from Buss-SMS GmbH.

As used herein, the term “lower-boiling inert solvents” means those solvents that have a boiling point lower than the diisocyanate monomer to be removed from the polyurethane prepolymer reaction product mixture. Preferably, such lower-boiling inert solvents have an atmospheric boiling point of from about 100° C. to about the atmospheric boiling point of the diisocyanate monomer to be removed. Also as used herein, the term “higher-boiling inert solvents” means those solvents that have a boiling point higher than the diisocyanate monomer to be removed from the polyurethane prepolymer reaction product mixture. Preferably, such higher-boiling inert solvents have a boiling point of from about 1° to about 50° C. higher than the boiling point of the diisocyanate to be removed. The boiling points (bp) and melting points (mp) of the materials described herein are at atmospheric pressure, or 760 mm Hg (760 Torr), unless otherwise noted. The lower-boiling inert solvents and the higher-boiling inert solvents used should not have a deleterious effect on the polyurethane polymer under the temperature and pressure conditions used to remove the unreacted diisocyanate monomer.

Suitable organic diisocyanates include paraphenylene diisocyanate (PPDI), 3,3′-dimethyl-4,4′-biphenylene diisocyanate (TODI), isophorone diisocyanate (IPDI), 4,4′-methylene bis (phenylisocyanate) (MDI), toluene-2,4-diisocyanate (2,4-TDI), toluene-2,6′-diisocyanate (2,6-TDI), naphthalene-1,5-diisocyanate (NDI), diphenyl-4,4′-diisocyanate, dibenzyl-4,4′-diisocyanate, stilbene-4,4′-diisocyanate, benzophenone-4,4′-diisocyanate, 1,3- and 1,4-xylene diisocyanates, 1,6-hexamethylene diisocyanate, 1,3-cyclohexyl diisocyanate, 1,4-cyclohexyl diisocyanate (CHDI), the three geometric isomers of 1, 1′-methylene-bis(4-isocyanatocyclohexane) (abbreviated collectively as H(12)MDI), and mixtures thereof. MDI and HDI are preferred.

The use of the lower-boiling inert solvent reduces diisocyanate monomer and distillate freeze-out on the cold trap and roof of agitated thin film or wiped film distillation equipment. It appears that the higher-boiling inert solvent works in conjunction with the lower-boiling inert solvent to condense internally, keeping the internal condensing surfaces free of diisocyanate crystals.

By adding both a lower-boiling inert solvent and a higher-boiling inert solvent to the polyurethane prepolymer reaction product mixture and then distilling the resultant mixture, a large amount of the unreacted diisocyanate monomer is effectively removed. Levels of unreacted diisocyanate monomer in the polyurethane prepolymer reaction product mixture obtained by this process are preferably less than 0.5% by weight of the polyurethane prepolymer reaction product mixture, and more preferably, less than 0.1%, and most preferably, less than 0.05%.

The ratio of the lower-boiling inert solvent to the higher-boiling inert solvent in the process of this invention can be from about 20:1 to about 1:20 (w/w), preferably about 10:1 to about 1:10 (w/w), and more preferably, about 2:1 (w/w).

The choice of inert solvents is dependent upon the boiling point of the individual diisocyanate monomer used and the prepolymer produced, as well as on the other reaction conditions.

The inert solvents are preferably added at the start of the prepolymer synthesis. This facilitates the removal of the unreacted diisocyanate monomer without requiring an additional distillation of the monomer from the solvents. The mixture of inert solvents and diisocyanate monomer can be collected as distillate and used in future synthesis of the isocyanate prepolymer.

The amount of the inert solvents added will generally depend on the particular polyurethane prepolymer reaction mixture being treated, the particular inert solvents employed, and the distillation conditions. Generally, the inert solvents are used, as a combination, in an amount from about 5 to about 85 percent based on the total weight of the polyurethane prepolymer reaction product mixture plus the solvents. A more preferred range is from about 10 to about 70 percent based on the total weight of the polyurethane prepolymer reaction product mixture plus the solvents.

This process can be conducted by adding the selected inert solvents during the synthesis of the crude polyurethane prepolymer reaction product derived from the reaction between an excess of organic diisocyanate monomer and a polyol, and then subjecting the resulting polyurethane prepolymer reaction product mixture to distillation conditions. The solvents may be added at any time during the reaction prior to the distillation.

The actual temperature and pressure conditions of the distillation should be such that the vaporization point of the diisocyanate monomer is exceeded without decomposing the polyurethane prepolymer. The actual temperature and pressure can vary therefore and are dependent upon the diisocyanate monomer being removed, the polyurethane prepolymer, other components of the polyurethane prepolymer reaction product mixture, and so on. If the monomer is MDI, the distillation temperature can range from about 120° C. to about 175° C. and the pressure can range from about 0.002 mm Hg to about 0.5 mm Hg.

Free NCO content can be determined by a procedure similar to that described in ASTM D1638-70, but employing tetrahydrofuran as the solvent.

The present invention requires that the LF prepolymers be first modified to incorporate internal emulsifiers, such as carboxyl-containing alcohols or polyols, e.g., dimethylol propionic acid and the like. They can also be modified with sulfonic group-containing moieties. For nonionic polyurethane dispersions, the LF prepolymers can be modified with reactants containing polyoxyethylene groups, such as methoxy polyoxyethylene monol or its amine terminated equivalents. They can also be made by reacting the LF prepolymer with a dihydroxy compound bearing a pendent methoxy polyoxyethylene as described in U.S. Pat. Nos. 5,714,561; 4,092,286; and 3,905,929. These and their derivatives are usually available in different molecular weights. For cationic polyurethane dispersions, the LF prepolymers are modified by reacting them with diols containing quaternary ammonium moieties, such as is described in U.S. Pat. No. 5,696,291.

The dispersions of the above described modified LF prepolymers are chain-extended in water with conventional diamine chain-extending agents, such as piperazine, hydrazines, adipic dihydrazide, ethylene diamine, hexamethylene diamine, hydroxyethyl ethylenediamine and the like. An alternative means for producing the chain-extending reaction is to allow the NCO end groups of the prepolymer to react with water, thereby producing urea segments in the backbone of the polyurethane polymer. In some instances, the chain-extending agents can include small amounts of triamine for cross-linking and improved properties.

Although the modified LF prepolymers contain internal emulsifying groups, external emulsifiers that are well known in the art can be added to the water prior to dispersing for added dispersion stability. Examples of such external emulsifiers include the nonyl phenol ethoxylates, ethoxylated alcohols, blocked PO/EO polymers, and the like.

There is no particular restriction to the way the dispersions are made from the modified LF prepolymers. The prepolymers can be added to water with high shear agitation, or water can be added to the prepolymer, the so-called inverse technique, with high shear mixing. The prepolymers of the present invention can be partially or totally blocked with known blocking agents, such as dimethylpyrazole, caprolactam, methyl ethyl ketoxime, phenol, triazine, and the like, prior to dispersion in water. These blocked or partially blocked dispersions can be used advantageously with other crosslinking reactants in a one component system.

The polyurethane dispersions of the present invention can be used advantageously to make gloves having improved comfort owing to the minimization or absence of the high cohesive energy polyureas that normally result from the reaction of free diisocyanate and chain-extending agents, such as diamines or water. The minimization of such polyureas lowers the moduli of the resulting gloves. Additionally, these polyurethane dispersions can be used in coating of variety of substrates, as well as in adhesives and sealants. They can also be formulated as binders for inks. They can be blended with other emulsions, such as acrylics and epoxies, and formulated with the usual additives for thickening, defoaming, wetting, and the like.

The advantages and the important features of the present invention will be more apparent from the following examples. Unless otherwise indicated, all parts are by weight.

### EXAMPLES

### Example 1

### Preparation of LF Prepolymers with an Internal Emulsifying Moiety

A) In a glass reactor equipped with a stirrer and a temperature controller was charged 698.5 grams of Adiprene LFM 300 (a prepolymer based on a MDI/Polyether adduct with a low free MDI level, average molecular weight 2760, obtained from Crompton Corporation, initial %NCO is about 3.1). The temperature was brought to 65-70° C. A solution of 15.5 grams of DMPA in 75 grams of 1-methyl-2-pyrrolidinone (NM1) was added to the LF prepolymer. The mixture was allowed to react at about 75-80° C. under a nitrogen atmosphere for about 1.5 hours until the NCO content reached the theoretically calculated value of 1.46%. The resulting prepolymer contained pendent carboxyl groups.

B) In a glass reactor equipped with a stirrer and a temperature controller was charged 874.5 grams of an LF prepolymer, LFM X-1300 (a prepolymer based on an MDI/Polyester adduct with a low free MDI level, average molecular weight 2600, obtained from Crompton Corporation, initial % NCO is about 3.2). The temperature was brought to 45-50° C. A solution of 25.3 grams of DMPA in 100 grams of 1-methyl-2-pyrrolidone (NMP) was added to the LF prepolymer. The mixture was allowed to react at about 45-50° C. under nitrogen atmosphere for about three hours until the NCO content reached the theoretically calculated value of 1.2%. The resulting prepolymer contained pendent carboxyl groups.

C) In a glass reactor equipped with a stirrer and a temperature controller, was charged 434.8 grams of an LF prepolymer, LFM 500 (a prepolymer based on an MDI/Polyether adduct with a low free MDI level, average molecular weight 1680, initial NCO % is about 5.04, obtained from Crompton Corporation). A quantity of 65.2 grams of melted Methoxycarbowax MPEG-750 was added to the LF prepolymer. The mixture was allowed to react at about 80° C. under a nitrogen atmosphere for about three hours until the NCO content reached the theoretically calculated value of 3.6%. The resulting prepolymer contained methoxy polyoxyethylene emulsifying groups.

D) In a glass reactor equipped with a stirrer and a temperature controller was charged 446.1 grams of LFM X1300 prepolymer with an initial NCO % of 3.2. A solution of 23.7 grams diethanoldimethyl ammonium methane sulfonate, (HEQAMS, available from Crompton Corp.) in 60 grams of NMP was added to the LF prepolymer. The mixture was allowed to react at about 60° C. under nitrogen atmosphere for about three hours until the NCO content reaches the theoretically calculated value of 1.14%. The resulting prepolymer at this stage contained quaternary ammonium moieties.

E) In a glass reactor equipped with an overhead stirrer and a temperature controller was charged 337 grams of an LF prepolymer, Adiprene JA6401 (a low free HDI based prepolymer with an average molecular weight of 1550 and an initial NCO % of 5.8, obtained from Crompton Corporation). A solution of 13.98 grams of DMPA in 149 grams of NMP was added to the LF prepolymer. The mixture was allowed to react at about 80° C. under nitrogen atmosphere for about three hours until the NCO content reached the theoretically calculated value of 2.1%. At this stage the resulting prepolymer contained pendent carboxyl groups.

### Example 2

### Preparation of Anionic Polyurethane Dispersions Based on Low Free MDI Prepolymers

About 0.001% of crystalline o-phosphoric acid, a reaction retarder, was added to the prepolymer of example 1A and the mixture was heated to 85° C. to lower viscosity. A quantity of 688.3 grams of the hot prepolymer was dispersed in 1260 grams of cold water at 15-20° C., containing 28.8 grams of external surfactant T-DET-N14 (from Harcross Chemical Inc) and 10.5 grams of triethylamine (TEA). After the prepolymer was completely dispersed, it was extended with 10.5 grams of 35% aqueous hydrazine solution. This resulted in a stable milky polyurethane dispersion with a solids content of 32.8% and a viscosity of 30 cps (Brookfield LVF, spindle #2 at 60 rpm and 25° C.). Polyurethane films were made by casting the polyurethane dispersion on a glass surface and by ionic deposition. The film properties appeared to be excellent for applications, such as medical devises, coatings, and adhesives.

### Example 3

To illustrate the usefulness of the dispersion of Example 2 in medical applications, 100% polyurethane gloves were made by ionic deposition using the following conventional technique.

The polyurethane dispersion was formulated with Surfactant Surfynol SE-F (0.4 part) and Defoamer Surfynol DF-37 (0.2 part per 100 parts of the polyurethane dispersion of the present invention). (Both materials are available from Air Products). Cleaned ceramic forms were heated for one minute at 100° C. and dipped in a standard coagulant solution (20% water solution of Ca (NO₃)2 thickened with 8% calcium carbonate) for 5 seconds. After drying at 120° C. for one minute, the coagulant coated forms were immersed in the formulated polyurethane dispersion for ten seconds. This was enough to obtain a film of 3-5 mils in thickness. The forms with deposited films were subjected to air drying for two minutes at 100° C. and leached for ten minutes in water at 60° C. and finally cured at 120° C. for 20 minutes to complete the process. The properties of the resulting glove were as follows: 100% modulus was 360 psi; 500% modulus was 2600 psi; tensile strength was 5500 psi; elongation at break was 650%; and IPA resistance was excellent.

### Example 4

### Preparation of Non-ionic Polyurethane Dispersions Based on Low Free MDI Prepolymer

The prepolymer of Example 1B (469 grams) was dispersed in 832 grams of cold water at 11-13° C. After the prepolymer was completely dispersed, the dispersion was chain-extended with 6.4 grams of 35% aqueous hydrazine solution. This resulted in a stable polyurethane dispersion having a solid content of 34.1% and a viscosity of 130 cps (Brookfield LVF, spindle #2 at 60 rpm and 25° C.).

Films were made by casting the polyurethane dispersion on a glass surface and air drying for several hours, after which they were annealed at 120° C. for 20 minutes. The films' mechanical properties were as follows: 100% modulus was 160 psi; 500% modulus was 340 psi; tensile strength was 1500 psi; and the elongation at break was 950%.

### Example 5

### Preparation of Anionic Polyurethane Dispersions Based on Low Free HDI Prepolymers

The prepolymer of Example ID (440 grams) was charged into a reactor, heated to 800 C, and then dispersed in 750 grams of cold water, at 11-13° C., containing 5.4 grams of external surfactant T-DET-N14 and 9.5 grams of TEA. After the prepolymer was completely dispersed, it was chain-extended with 9.0 grams of 35% aqueous hydrazine solution. This resulted in a stable polyurethane dispersion having a solids content of 31.8% and a viscosity of 430 cps (Brookfield LVF, spindle #2 at 60 rpm and 25° C.). Polyurethane films were made by casting the polyurethane dispersion on a glass surface and air drying for several hours, after which they were annealed at 120° C. for 20 minutes. The film mechanical properties were as follows: 100% modulus was 910 psi; 500% modulus was 2800 psi; tensile strength was 5000 psi; and the elongation at break was 650%.

### Example 6

### Preparation of Anionic Polyurethane Dispersions Based on Low Free MDI Prepolymers Without Organic Co-Solvent

Into a glass reactor equipped with an overhead stirrer and a temperature controller was charged 446.7 grams of LFM X1300. The temperature was brought to 45-50° C. and 53.3 grams of CAPA 587047, a carboxylic functional polyol, was added. The mixture was allowed to react at about 45-50° C. under a nitrogen atmosphere for about three hours until the NCO content reached the theoretically calculated value of 1.37%. The prepolymer was dispersed in 930 grams of cold water, at 11-13° C., that contained 19.6 grams of external surfactant T-DET-N14 and 7.49 grams of TEA. After the pre-polymer was completely dispersed, the dispersion was chain-extended with 6.4 grams of 35% aqueous hydrazine solution. This resulted in a stable polyurethane dispersion having a solids content of 33.1% and a viscosity of 70 cps (Brookfield LVF, spindle #2 at 60 rpm and 25° C.). Polyurethane films were made by casting the polyurethane dispersion on a glass surface, drying at room temperature for several hours, and annealing in an oven at 120° C. for 20 minutes. The films' mechanical properties were as follows: 100% modulus was 220 psi; 500% modulus was 1850 psi; tensile strength was 4300 psi; and the elongation at break was 650%.

### Comparative Example A

### Preparation of Anionic Polyurethane Dispersions from MDI and Polyester Polyol

Into a glass reactor equipped with an overhead stirrer and a temperature controller was charged 393.3 grams of FOMREZ 22-56 (a polyethylene glycol adipate of MW 2000, available from Crompton Corp.), which was then heated to 65° C. In a second step, 96.07 grams MDI was added and the temperature increased to 75° C. After one hour, NCO % was measured as 3.2. The reaction was cooled down to 50° C. and a solution of 10.65 grams of DMPA in 45 grams of 1-methyl-2-pyrrolidone (NMP) was added to the prepolymer. The mixture was allowed to react at about 45-50° C. under nitrogen atmosphere for about three hours. The final NCO % was 1.19, which is close to the theoretically calculated value (1.21%). At this stage, the prepolymer viscosity was too high, which made it difficult to disperse in 840 grams of cold water at 11-13° C. containing 18.4 grams of external surfactant T-DETN14 and 7.3 grams of TEA. After the pre-polymer was completely added to the water, the dispersion was chain-extended with 8.02 grams of 35% aqueous hydrazine solution. The resulting dispersion had a lot of grit and was impossible to filter. The dispersion did not form a uniform film when cast on glass plate. Clearly, this example illustrates the difficulty in making useful dispersions from conventional MDI prepolymers, as compared to the ease of making dispersions from the modified LF prepolymer of Example 2.

### Comparative Example B

### Preparations of Non-anionic Polyurethane Dispersions from MDI and Polyester Polyol

Into a glass reactor equipped with an overhead stirrer and a temperature controller was charged 393.3 grams of FOMREZ 22-56, which was then heated to 65° C. In a second step, 96.07 grams of MDI was added and the temperature increased to 75° C. After one hour, the NCO content was measured as 3.2%. The reaction was cooled down to 50° C. and 118 grams of Methoxycarbowax (MPEG-750) was added. The mixture was allowed to react at about 80° C. under a nitrogen atmosphere for about three hours until the NCO content reached the calculated value (1.12%). Attempts to disperse the resulting prepolymer failed. The prepolymer formed a gel in water before it could be extended. This example also illustrates the difficulty of making dispersions from conventional MDI prepolymers as compared to the modified LF prepolymer of Example 4.

### Comparative Example C

### Preparation of Anionic Polyurethane Dispersion from Conventional HDI Prepolymer

Into a glass reactor equipped with a stirrer and a temperature controller was charged 279.4 grams of FOMREZ 66-112, which was then heated to 45° C. Next, 102.6 grams of HDI was added and the temperature increased to 100° C., after which it was cooled to 95° C. and kept at this temperature for one hour. At this stage of the reaction, a sample was analyzed for % NCO content. It was found to be 6.5%. The reaction was cooled down to 70° C. and 18.5 grams of DMPA in 197 grams of M-Pyrol solvent was added. The mixture was allowed to react at about 80° C. and under a nitrogen atmosphere for an additional 1.5 hours, whereupon the NCO content reached the theoretical 2.35%. The resulting prepolymer was dispersed in 1050 grams of cold water (11-13° C.) containing 12.4 grams of external surfactant T-DET-N14 and 13.1 grams. of triethylamine. After the prepolymer was dispersed it was chain-extended with 12.5 grams of 35% aqueous hydrazine. The resulting dispersion was extremely gritty and gelled in a 50° C. oven after 5 days. Comparison of this example with Example 5 shows the advantages of the modified LF prepolymer in making dispersion.

In view of the many changes and modifications that can be made without departing from principles underlying the invention, reference should be made to the appended claims for an understanding of the scope of the protection to be afforded the invention.

What is claimed is:

1. A composition of matter comprising a low free-diisocyanate polyurethane prepolymer modified by the addition of pendent anionic, cationic, or nonionic moieties.

2. A method for making an aqueous polyurethane dispersion comprising subjecting a low free-diisocyanate polyurethane prepolymer modified by the addition of pendent anionic, cationic, or nonionic moieties to high shear mixing in the presence of water.

3. The method of claim 2 further comprising the step of adding a reaction retarder to the prepolymer.

4. The method of claim 3 wherein the reaction retarder is crystalline o-phosphoric acid.

5. An aqueous polyurethane dispersion prepared by a process comprising subjecting a low free-diisocyanate polyurethane prepolymer modified by the addition of pendent anionic, cationic, or nonionic moieties to high shear mixing in the presence of water.

6. The dispersion of claim 5 wherein said dispersion is free of organic solvents.

7. The dispersion of claim 5 wherein said dispersion is free of M-pyrol.

8. An article of manufacture prepared from an aqueous polyurethane dispersion prepared by a process comprising subjecting a low free-diisocyanate polyurethane prepolymer modified by the addition of pendent anionic, cationic, or nonionic moieties to high shear mixing in the presence of water.

9. The article of claim 8 wherein the article is a glove.

10. The article of claim 8 wherein the article is an adhesive.

11. The article of claim 8 wherein the article is a coating.

12. The article of claim 8 wherein the article is a sealant.

13. The article of claim 8 wherein the article is ink.

14. The composition of claim 1 wherein the pendent moiety is anionic.

15. The composition of claim 14 wherein the anionic moiety is a carboxyl group.
